(19) United States
(12) Patent Application Publication
(10) Pub. No.: US 2009/0228302 A1
(43) Pub. Date: Sep. 10, 2009

(54) System and method of prescribing alternative medications

(75) Inventor: Leigh M. Rothschild, Sunny Isles Beach, FL (US)

Correspondence Address: CASELLA & HESPOS, 274 MADISON AVENUE, NEW YORK, NY, 10016, US

(73) Assignee: LMR Inventions, LLC, Sunny Isles Beach, FL (US)

(21) Appl. No.: 12/381,047

(22) Filed: Mar. 6, 2009

Related U.S. Application Data
(60) Provisional application No. 61/068,313, filed on Mar. 6, 2008.

(51) Int. Cl. G06Q 50/00; G06Q 30/00; G06Q 90/00

(52) U.S. Cl. 705/3; 705/14

(57) ABSTRACT

A system and method is provided to allow a physician to consider alternative medications while he is electronically prescribing medications to the patient, and to also allow the physician to be aware of and provide free medications and/or rebates to the patient.

### PRIORITY

This application claims priority to U.S. Provisional Patent Appl. No. 61/068,313, filed Mar. 6, 2008, the contents of which are hereby incorporated by reference in its entirety.

### BACKGROUND

1. Field

A system and method is provided to allow a physician to consider alternative medications while he is electronically prescribing medications to a patient, and to also allow the physician to be aware of and provide free medications and/or rebates to the patient.

2. Description of the Related Art

Over 3.2 billion prescriptions are written by physicians each year in the United States. The writing of prescriptions is now being modernized to fit into the modern computer society. A system of electronically prescribing medications to patients has been developed by a number of companies including a consortium under the NEPSI heading (National EPrescribing Patient Safety Initiative; see Http://www.nationalerx.com/sponsors.htm).

Another company providing computer software for electronic prescriptions is RxNT located in Annapolis, Md. The e-prescription initiative means that a physician or authorized party (nurse practitioner, etc.) can use an electronic device including a cell phone, pda, laptop, tablet or desktop computer, etc. to perform the following functions.

1. Review a patient's information including patient history. 2. Select a suitable medication for the patient and pick dosage and frequency (Or Alternatively let the eprescribing system suggest a medication). 3. Check the medication for allergies and drug interactions, etc. with a Drug Utilization Review (DUR). 4. Send the prescription to the patient's pharmacy and/or health plan provider. 5. Provide the patient with a copy of the prescription. 6. Update the physicians or practice's records with information on the prescription.

As the costs of prescription medicine continues to increase, a trend in the medical industry that has also increased is giving away free medication samples to physicians to give to the patients to use. A recent study which appears in the American Journal of Public Health estimates that one in ten Americans received one or more free samples in 2003. The free samples allow the patients to test the medications and also lowers the patients' costs in using the medication.

The current system for dispensing the free medication is for a drug representative or drug company to either deliver or send the free samples to a qualified physician or qualified practice and for the physician or another authorized person (e.g. nurse practitioner) to give out the samples.

Another alternative in the system allows the patient to request a free sample directly from the drug manufacturer providing he/she sends the drug manufacturer an authorized prescription from the physician. Examples of medication samples include NasaCort, Nasonex and Viagra. Examples of drug manufacturers providing samples directly to the patients include the consumer oriented campaign that AstraZeneca Pharmaceuticals ran for the drug Crestor.

A need exists to allow the physician to direct free medical samples/rebates or alternative medications during the electronic prescribing (i.e., e-prescribing) process. Currently, there is no system or method for a physician to check to see if a free medication sample would be available for the patient or, alternatively, a rebate on a medication while he is e-prescribing a medication for a patient. This deficiency results in higher cost, and less information, for the patient. Further, there also exists a need for a physician to be able to choose between competing medications during the electronic prescribing process. Currently electronic prescribing systems suggest alternative medications to the physician, but this suggestion is based on compilations of medications in a medication database and not direct input or information from a medication manufacturer.

By example, if a physician is currently e-prescribing NasaCort to a patient, the electronic database may suggest an alternative medication such as Nasonex. However, this suggestion is without input from the Nasonex manufacturer who if they had input would be able to offer the physician and the patient free samples of the medication, rebates on the medication, or other up to date and pertinent information on the medication. Further, allowing the medication manufacturers direct input in the electronic prescribing process will allow the medication manufacturers to offer compensation to the organizers of the e-prescibing programs.

### SUMMARY

A system and method of recommending alternative medications to a physician within the electronic prescribing process and providing free medication (samples), product information, or rebates to the patient is provided. The system and method provide for tagging an electronic prescription database so that one listed medication links to another alternative medication. Once the medication has been tagged, the system and method enables the displaying of the alternative medication information on a physician (users) data display terminal, e.g., a desktop computer or a portable device, after a medication is selected by the physician.

The alternative medication information includes information on providing the patient free user samples. The system and method provides for having the physician electronically elect to receive these alternative medication samples directly. Alternatively, the system and method allows the patient to receive the medication samples directly by having the physician electronically direct the samples from the manufacturer to the patient.

Furthermore, the alternative medication information includes information on patient rebates for the alternative medication. The system and method provides for sending these rebate offers electronically during the e-prescribing process to the physician, sending these rebate offers electronically during the e-prescribing process to the patient or printing out these rebate offers at the physician's office.

The system and method provides other alternative medication information on the selected medication, e.g., possible side effects, wherein the system and method allows the physician to print out information on the alternative medication or e-mail the patient information on the alternative medication.

The system and method of the present disclosure further enables a medication manufacturer access to the medication listings on the electronic prescription database so that they can tag these medications with information that would allow the physician to see alternative medications that the medication manufacturer is suggesting.

In one embodiment, the medication manufacturer is charged in an e-commerce transaction a fee or fees for tagging these medications with information that would allow the physician to see alternative medications that the medication manufacturer is suggesting.

In another embodiment, the medication manufacturer is charged in an e-commerce transaction a fee or fees for tagging these medications with information that would allow the physician to see alternative medications that are available for free to the patient or physician.

In a further embodiment, the medication manufacturer is charged in an e-commerce transaction a fee or fees for tagging these medications with information that would allow the physician to see alternative medications that are available for patient rebates.

In yet another embodiment, the medication manufacturer is provided with a control panel that will remotely access a database of medications so that the manufacturer can tag these medications so that when accessed they link to the medications/information/offers that the manufacturer is providing.

### BRIEF DESCRIPTION OF THE DRAWINGS

The above and other aspects, features, and advantages of the disclosure will become more apparent in the light of the following detailed description when taken in conjunction with the accompanying drawings in which:

FIG. 1 is an overall flow diagram of a system and method for prescribing alternative medications in accordance with an embodiment of the present disclosure; and

FIG. 2 is a flow chart illustrating a method for prescribing alternative medications in accordance with an embodiment of the present disclosure.

### DETAILED DESCRIPTION

Preferred embodiments of the disclosure will be described hereinbelow with reference to the accompanying drawings. In the following description, well-know functions or constructions are not described in detail to avoid obscuring the disclosure.

Embodiments of the present disclosure overcome the shortcomings of existing practices and provides a system and method for a physician to recommend alternative medications using an electronic prescribing process which provides free medications, product information and possible rebates to the patient.

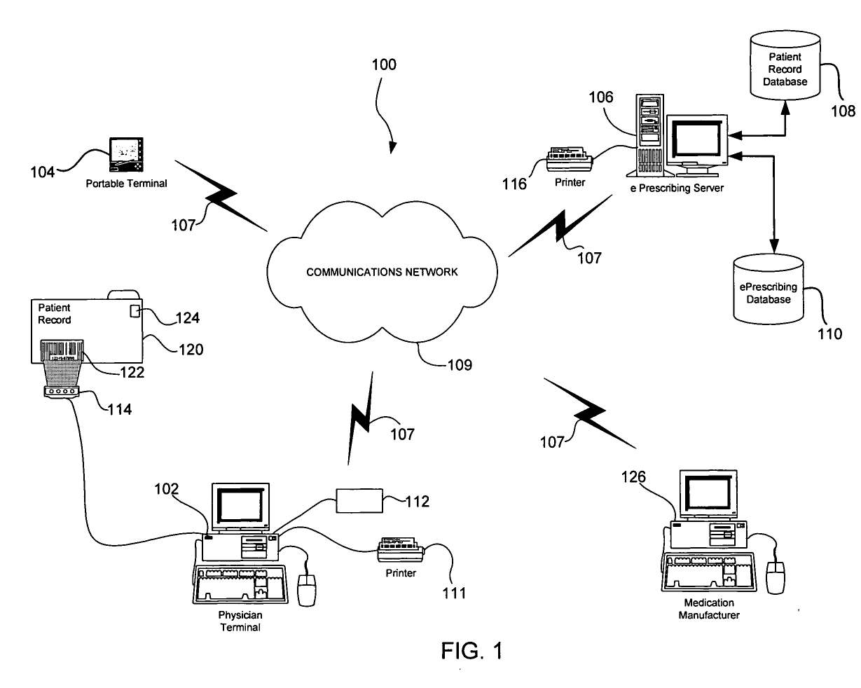

Referring to FIG. 1, an overall flow diagram of a system and method for prescribing alternative medications is illustrated. Generally, the system 100 includes a terminal 102 for accessing server 106 by a user, e.g., a physician, over communications network 109, e.g., the Internet, LAN, WAN, or other suitable network. The prescribing server 106 is configured for prescribing medications for a particular patient to a user of the system for example a physician. The prescribing server 106 is coupled to a first patient record database 108 and a second e-prescribing database 110. The patient record database 108 includes a plurality of records, each record includes data for an individual patient, e.g., medical history, allergies to certain medicines, etc. The e-prescribing database 110 includes a plurality of listings for each available medication and an associated listing which includes information on possible alternative medications, whether a rebate or free sample is available for the alternative medications, among other information.

In one embodiment, the terminal 102 is a desktop computer 102 and, in other embodiments, the physician can access the system 100 using a portable viewing device 104. Terminal 102 and server 106 will communicate using any conventional architecture, for example a client/server architecture where terminal 102 will execute a client application, e.g., a web browser, to access an application executing on server 106. Terminal 102 will access server 106 to enable a user to transmit an identifier from a patient folder or physical record 120. Server 106 will receive the identifier affixed to file folder 120 and use the identifier to retrieve the patient's record from the patient record database 108. The identifier identifies the location of the patient record on remote server 106. In one embodiment, scanner 114 will read the identifier, e.g., a barcode 122, from the file folder and determine the patient record. In another embodiment, identification tag 124 will transmit a unique code to an electronic identification tag reader and/or any other type of device that can receive, store, and transmit information to a reader/receiver coupled to terminal 102. Terminal 102 will include communication module 112 for communicating to remote server 104.

Alternatively, the physician can access the system 100 using a portable viewing device 104 which may be carried by the physician while visiting each patient. In one embodiment, the mobile stand-alone device 104 contains a computer processor and a communications port, such as via Bluetooth™, Wi-Fi, Universal Serial Bus (USB™) cable, infrared, or any other data transmission system now known or to be developed. The physician can use the mobile stand-alone device 104 to recognize the identifier of the patient record. In one embodiment, the portable device 104 includes a reader for reading the identifier 122 or tag 124 associated with the physical patient record. The reader for reading the identifier includes but is not limited to a barcode scanner, a imaging device (such as a CCD encoding device), an electronic tag reader or any other known or to be developed device for reading and decoding an identifier or symbology located on the physical file folder. Once the identifier is read by the device 104, the device 104 will transmit the identifier via the communications port to the server and the device 104 will present the patient record to the physician via a display device. The physician can then select a medication for the patient and subsequently be presented with an alterative medication along with any associated offers as will be described below.

Generally, when a physician desires to prescribe a medication for a patient, the physician will access the e-prescribing server 106 via a terminal 102, 104. The physician retrieves a record associated to the patient by entering the name of the patient or entering a code associated or assigned to the patient, e.g., the identifier located on the patient record 120. The server 106 will use the patient code or identifier while accessing the patient record database 108 to retrieve the patient record. Based on data in the patient record, the physician selects a medication for the patient. The e-prescribing server 106 will then access the e-prescribing database to determine if the medication has any alternative listings associated with it. If any alternative medications are available, the alternative mediations will be presented to the physician at the terminal 102, 104. The physician will also be provided with any other information that is associated to the alternative medication, for example, if a rebate is available, if free samples are available, possible drug interaction warnings, etc. At this point, the physician can make an informative decision on which medication to finally prescribed to the patient.

It is to be understood that the present disclosure may be implemented in various forms of hardware, software, firmware, special purpose processors, or a combination thereof. In one embodiment, the present disclosure may be implemented in software as an application program tangibly embodied on a program storage device. The application program may be uploaded to, and executed by, a machine, e.g., terminal 102 or server 106, comprising any suitable architecture such as a personal computer, a workstation or server. Preferably, the machine is implemented on a computer platform having hardware such as one or more central processing units (CPU), a random access memory (RAM), a read only memory (ROM) and input/output (I/O) interface(s) such as a keyboard, cursor control device (e.g., a mouse or joystick) and display device. A system bus couples the various components and may be any of several types of bus structures including a memory bus or memory controller, a peripheral bus, and a local bus using any of a variety of bus architectures. The computer platform also includes an operating system and micro instruction code. The various processes and functions described herein may either be part of the micro instruction code or part of the application program (or a combination thereof) which is executed via the operating system.

In addition, various other peripheral devices may be connected to the computer platform of the machine by various interfaces and bus structures, such a parallel port, serial port or universal serial bus (USB). One such peripheral device may include a communications device, e.g., a modem, satellite relay, wireless connection, etc., for enabling communications from terminal 102 to various servers. Other peripheral devices may include additional storage devices, printers 111, 116 and scanner 114.

It is to be further understood that, because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

Terminal 102, 104 and/or server 106 may operate in a networked environment using logical connections to one or more remote computers. The remote computer may be a personal computer, a server, a router, a network PC, a peer device or other common network node, and typically includes many or all of the elements described above relative to the machine. It is to be appreciated that network 109 may be a local area network (LAN), wide area network (WAN), the Internet or any known network that couples a plurality of computers to enable various modes of communication via network messages. Terminal 102, 104 may communicate to the server 106 and network 109 via any known communication link 107, for example, dial-up, hardwired, cable, DSL, satellite, cellular, PCS, wireless transmission (e.g., 802.11a/b/g, etc.), etc. Furthermore, the devices will communicate using the various known protocols such as Transmission Control Protocol/Internet Protocol (TCP/IP), File Transfer Protocol (FTP), Hypertext Transfer Protocol (HTTP), etc. During a purchasing transaction, the computing devices may employ Hypertext Transfer Protocol Secure (HTTPs), Secure Sockets Layer (SSL) Protocol, Secure Electronic Transaction (SEC) Protocol, etc.

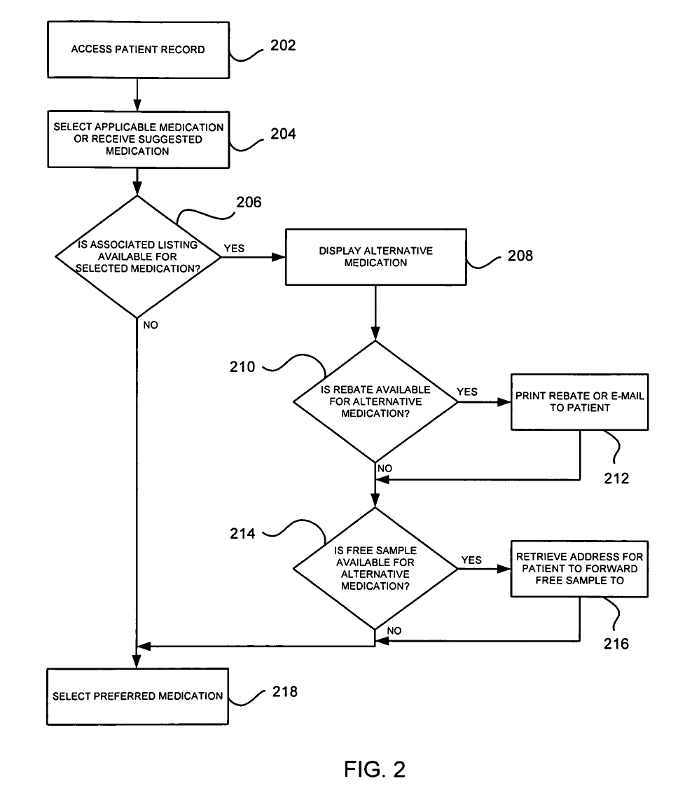

Referring to FIG. 2, flow chart illustrating a method for prescribing alternative medications in accordance with an embodiment of the present disclosure will be described.

Initially, a physician accesses the electronic database system to write an electronic prescription such as RxNt. The physician selects the applicable patient, in step 202, and the applicable medication or alternatively the electronic system selects the medication, in step 204. The physician, my select the applicable patient by entering identifier into terminal 102, 104 from the patient record 120. Identifier may be the name of patient, the number convention that the files are identified by, etc. It is to be appreciated identifier may be placed on the patient record 120 itself or it may be placed on a tab. Identifier (a printed tab or handwritten tab) may be directly affixed onto the patient record 120 or placard. In one embodiment, identifier includes a bar code 122 or an alpha-numeric string. If identifier for the patient record 120 is handwritten or printed without a barcode, the entry into user terminal 102, 104 is manual. A manual entry could include any method now known or developed in the future including, but not limited to, using a keyboard, voice recognition software, etc. If the printed identifier has a bar code 122, the code may be scanned via a scanner 114 coupled to the user terminal 102. Terminal 104 may include a barcode type scanner or may employ a CCD type device to acquire the identifier from the patient record 120.

In another embodiment, the patient record 120 also includes an electronic identification tag 124. There are various types of electronic identification tags known in the art including, but not limited to, Radio Frequency Identification Device (RFID) tags, electric identification, and transponders of various types and any other type of device that can receive, store and transmit information. The tag 124 will includes an identification code indicating the associated physical file folder. The tag 124 will wirelessly transmit the identification code to the user terminal 102, 104 when the file folder is within a predetermined distance of the user terminal 102, 104.

Based on the information stored in the patient record retrieved from database 108, the physician will select the medication most appropriate for the particular patient. Alternatively, the e-prescribing server 106 will select the appropriate medication and present the selection to the physician at terminal 102, 104.

Once the medication is selected, the e-prescribing server 106 checks the database 110 to see if there is an associated listing stored by a medication manufacturer for the selected medication, in step 206. This listing may include information on an alternative medication, e.g. the physician or system selects Nasonex and the database 110 for Nasonex contains a flag to NasaCort that was placed there by the manufacturer of NasaCort. The NasaCort data includes information on a free sample of NasaCort that is available to the patient or physician. The associated listing (in this example information on the alternative medication NasaCort) is displayed on the users display terminal 102, 104, in step 208.

The e-prescribing server 210 will then check the associated listing to see if any offers (e.g., free samples, rebates, information, etc.) are available for the alternative mediation. If the offer from the manufacturer is a rebate, in step 210, then the rebate coupon can be (a) printed and presented to the physician or patient at the physician's office or (b) emailed to the patient, in step 212. Furthermore, the physician may provide an indication to the terminal 102, 104 where to e-mail the rebate to, e.g., an e-mail address of the patient that is stored in the patient record from database 108.

If the offer from the manufacturer is a free sample of the medication, in step 214, then the physician would indicate the address that he wishes the medication to be sent to or the address of the patient will be automatically retrieve from the patient record database 108. Address possibilities would include the address of the physician or the direct address of the patient. Based on the alternative medication and associated offers, the physician can then make an informative decision on which medication to prescribe for the patient.

Furthermore, if the manufacturer wants to present the physician with information on the alternative suggested medication (in this case NasaCort) then the physician would be able to print out this information, or alternatively have the information e-mailed to him or to the patient.

In the above embodiment of the present disclosure, a drug manufacturer would have access to all the medications that are in the electronic prescribing database 110 and this manufacturer would be able to tag any of these medications with alternative medications and information including free samples, manufacturer rebates, and information on competing medications via medication manufacturer terminal 126. In this embodiment, the medication manufacturer will access the e-prescribing database 110 via terminal 126 over secure protocols such as Hypertext Transfer Protocol Secure (HTTPs), Secure Sockets Layer (SSL) Protocol, Secure Electronic Transaction (SEC) Protocol, etc. including various layers of password protection to ensure the integrity of the database 110. In this manner only authorized parties will be allowed to access the database 110. Furthermore, the medication manufacturers may be restricted or limited, e.g., by assigned passwords or other means, to only access certain drugs for tagging. By example, a cholesterol lowering drug company such as Crestor could only tag cholesterol drugs.

In another embodiment of the present disclosure, the manufacturer would have a control panel, e.g., terminal 126, that would allow him to remotely access and enter this information from his local processor to the remote database server 106 that is providing the electronic prescriber information. Of course the manufacturer could update the information and offers dynamically as often as he/she wanted.

In one embodiment, the medication manufacturer will be charged a fee via an e-commerce transaction per listing associated to a medication or per information update to the e-prescribing company running the system 100 or maintaining the server 106 and database 110. In the above example, NasaCort's manufacturer Sanofi-aventis U.S. LLC would pay e-prescriber a fee for the offer for free samples, and another fee if offering a manufacturer rebate, and another fee if providing information on their product. Of course, such fees might be aggregated into one package fee depending on the program fees of the company running the e-prescribing system 100. While this disclosure has been shown and described with reference to certain preferred embodiments thereof, it will be understood by those skilled in the art that various changes in form and detail may be made therein without departing from the spirit and scope of disclosure of the appended claims.

What is claimed is:

1. A method for prescribing alternative medications, the method comprising:
receiving an identifier associated with a patient;
accessing a record associated to the patient using the received identifier;
receiving a selection of at least one medication for the patient;
determining an alternative medication for the patient based on the selection and the patient record; and
presenting the determined alternative medication and at least one offer associated to the determined alternative medication.

2. The method as in claim 1, wherein the at least one offer is information relating to the determined alternative medication.

3. The method as in claim 1, wherein the at least one offer is a free sample of the determined alternative medication.

4. The method as in claim 3, further comprising receiving an indication where to send the free sample.

5. The method as in claim 1, wherein the at least one offer is a rebate for the determined alternative medication.

6. The method as in claim 5, wherein the rebate is e-mailed to the patient.

7. The method as in claim 5, further comprising receiving an indication where to send the rebate.

8. The method as in claim 5, further comprising printing the rebate at a physician's office.

9. The method as in claim 1, further comprising tagging the at least one medication with a listing for at least one alternative medication.

10. The method as in claim 9, wherein the listing is at least one of information relating to the at least one alternative medication, a free sample of the at least one alternative medication, or a rebate for the at least one alternative medication.

11. The method as in claim 10, further comprising charging a transaction fee for each listing tagged to the at least one medication.

12. The method as in claim 11, wherein the tagging is performed remotely from the determining and presenting.

13. The method as in claim 11, further comprising restricting access to the at least one medication to a related medication manufacturer.

14. A system for prescribing alternative medications over a network comprising:
at least one first terminal configured for transmitting an identifier associated with a patient to a server;
the server configured for receiving the identifier associated with the patient, accessing a record associated to the patient using the received identifier, receiving a selection of at least one medication for the patient, determining an alternative medication for the patient based on the selection and the patient record and presenting the determined alternative medication at the at least one first terminal; and
a communications network for coupling the at least one terminal and the server,
wherein the at least one first terminal is further configured for presenting at least one offer associated to the determined alternative medication.

15. The system as in claim 14, wherein the at least one offer is information relating to the determined alternative medication.

16. The system as in claim 14, wherein the at least one offer is a free sample of the determined alternative medication.

17. The system as in claim 16, wherein the at least one first terminal is further configured for transmitting an indication to the server of where to send the free sample.

18. The system as in claim 14, wherein the at least one offer is a rebate for the determined alternative medication.

19. The system as in claim 18, wherein the server is configured for e-mailing the rebate to the patient.

20. The system as in claim 18, wherein the at least one first terminal is further configured for transmitting an indication to the server of where to send the rebate.

21. The system as in claim 18, wherein the at least one first terminal includes a printing device for printing the rebate at a location of the at least one first terminal.

22. The system as in claim 14, further comprising at least one second terminal configured for tagging the at least one medication with a listing for at least one alternative medication.

23. The system as in claim 22, wherein the listing is at least one of information relating to the at least one alternative medication, a free sample of the at least one alternative medication, or a rebate for the at least one alternative medication.

24. The system as in claim 23, wherein the server is configured for charging the at least one second terminal a transaction fee for each listing tagged to the at least one medication.

25. The system as in claim 22, wherein the at least one second terminal is located remotely from the server.

26. The system as in claim 22, wherein the at least one second terminal has restricting access to the at least one medication based on a predefined criteria.

27. The system as in claim 14, wherein the at least one first terminal is a portable terminal.

28. An apparatus for prescribing alternative medications comprising:
means for receiving an identifier associated with a patient;
means for accessing a record associated to the patient using the received identifier;
means for receiving a selection of at least one medication for the patient;
means for determining an alternative medication for the patient based on the selection and the patient record;
means for presenting the determined alternative medication; and
means for presenting at least one offer associated to the determined alternative medication,
wherein the at least one offer is at least one of information relating to the at least one alternative medication, a free sample of the at least one alternative medication, or a rebate for the at least one alternative medication.
